(19) United States
(12) Patent Application Publication
(10) Pub. No.: US 2009/0204461 A1
(43) Pub. Date: Aug. 13, 2009

(54) METHOD AND SYSTEM FOR WORKFORCE OPTIMIZATION

(75) Inventors: Prashant Jain, Delhi (IN); Gyana Ranjan Parija, Haryana (IN); Anupam Saronwala, New Delhi (IN); Anju Tandon, New Delhi (IN)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 12/030,283

(22) Filed: Feb. 13, 2008

(51) Int. Cl. G06Q 10/00

(52) U.S. Cl. 705/8; 705/7

(57) ABSTRACT

A system for workforce optimization in a service oriented industry, the system comprising a workforce optimization unit configured for planning and executing a business scheme which include providing as input business planning parameters relevant to the business scheme; developing a business plan to execute the business scheme based on the business planning parameters; identifying and allocating relevant resources for executing the business plan; intimating the identified resources with the plan to execute the business scheme.

### CROSS-REFERENCE TO RELATED APPLICATIONS

This application is a related to co-pending application Ser. No. ______ filed concurrently herewith to Prashant Jain et al., entitled “A Method and System For Workforce Optimization,” having Attorney Docket Number IN920070095US1, having the same Assignee, the complete disclosure of which, in its entirety, is herein incorporated by reference.

### BACKGROUND

1. Field of the Invention

The present invention relates to workforce optimization, in particular to workforce optimization in service oriented industry.

2. Description of Related Art

Today, many enterprises are adopting the philosophy that IT projects are not an end to themselves, but rather a means to enable and help realize enterprise business objectives. Many of these enterprises (and the technology companies that support them) are also recognizing that business process optimization often provide much greater business gains than any IT project optimizations.

Business optimization and IT optimization efforts are not mutually exclusive; they can occur concurrently. However, it may be asserted that the primary focus of IT should be to support the business needs. Meaning that rather than just trying to make IT more efficient, focus first on making sure that IT is solving the correct (business) problems. This focus on IT delivering the correct business solutions characterized as business-driven development. A challenge that arises is towards articulating an enterprises business goals and opportunities for business improvement, and then quickly translates those to the IT systems that may support that area of business.

Many companies are realizing that a good way to accomplish this is to utilize enterprise-level modeling and service orientation, which can be used as the basis for mapping business goals to the relevant or impacted portions of the modeled business and, in turn, to the modeled IT architecture. In addition, if service orientation is used to realize IT capabilities, and then map those IT capabilities directly to the business architecture that are support, then the ability to quickly understand the IT implications when those business processes have to be changed is achieved, which can result in a more agile enterprise.

A further challenge that companies confront when deciding to take this strategic, enterprise-level modeling and service-oriented approach, is that the process of creating these models from scratch can be arduous, expensive, and take too long to complete. Rather than take on this start from scratch process, many companies elect instead to purchase an already completed set of interrelated enterprise models based on best practices within their industry.

For example, consider the banking industry which view industry/business financing as a high growth opportunity, with a good percentage of income coming from net interest income. Banks provide a range of products and services including working capital finance, project term loans, corporate term loan, structured finance, dealer finance, channel finance, equipment leasing, loan syndication, and cash management services. The banking segment supplies capital for business ventures to large and medium sized businesses. Typically, the banking segment accounts for more than 60 per cent of the banking assets and is the main business for the banks. Banks are also partnering with Financial Institutes for jointly syndicating and financing large infrastructure and core industrial projects, across the globe. In future, banks can foresee higher interest based income by providing capital to small and medium enterprises, and are adopting policy packages for stepping up faster credit to small and medium enterprises.

The prime driver is specialized skills required for this service. The industry financing institutions and banks are coming together to share the skill sets developed over a period of time, to syndicate/underwrite the debt and extend total financial solution for large projects coming up in the public private partnership domain as well as in the private sector. As banks target higher growth in this sector, the talent for identification, marketing and appraisal of syndicated loans with underwriting arrangements will be in demand. Banks offering loans through structured appraisals leading to quick decisions and competitive terms will be leaders in the market. Further, the key differentiators for leading banks will be value added services and that will have high dependency on specialized skills and process management including fund/cash management, resource management, treasury management, project loan management etc.

Process management across the service oriented industry is to ensure a match of available resources to the services that the organization is required to deliver. In such process management, the main resources are the service professionals, for example field service engineers, help desks or call center agents, insurance assessors, business consultants, and the likes, with their availability depending on a number of governing factors. Further, for the process management to be successfully executed, dependency on other resources include vehicles, tools and equipment, spare parts, office space (e.g., meeting rooms), etc. Services are usually initiated by customer demands, and typically, they are not predictable on the micro-level. There is no way to predict when a specific customer will call and request a service.

Based on scenarios that are encountered in the present, there is also no way to predict when a specific customer will call and request a service, and predicting such scenarios and allocating proper resources is a time consuming tasks with several disadvantages of accurately managing the size, mix of skills and regional allocation of its resources to meet future unknown, unpredictable demands and so on. Erring by allocating too few resources results in failing to meet customer expectations, risking losing customers, and sometimes also requiring the service organization to pay contract-specified penalties. For example, erring by allocating too many resources results in spending excessive money on resources that are not fully utilized. Again, time cannot be stored, and thus every hour that a resource is not utilized is lost forever (this is in contrast to manufacturing of physical goods, in which extra machine capacity may be used to produce a stock which will be sold later). Obviously, it is not enough to decide on one group of service professionals for the whole organization which can address the service request of the customer. The decision needs to pare down to some extent (depending on the organization and various other multiple factors).

Without a way to improve the determination and allocation of resource to services in the service oriented industry, the promise of this technology may never be fully achieved.

### SUMMARY

Embodiments disclosed herein address the above stated needs by providing methods, systems and computer products for optimizing workforce in service oriented industries.

A method, system and computer program product for workforce optimization in a service oriented industry, the method comprising planning and executing a business scheme which include providing as input business planning parameters relevant to the business scheme; developing a business plan to execute the business scheme based on the business planning parameters; identifying and allocating relevant resources for executing the business plan; intimating the identified resources with the plan to execute the business scheme. In a preferred embodiment, the service oriented industry is banking or a financial transaction institution.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 illustrates an exemplary embodiment of an architecture for workforce optimization in accordance with the present invention;

FIG. 2 illustrates a flow diagram of an exemplary method for optimizing workforce in accordance with the present invention; and

FIG. 3 is a computer system suitable for implementing various embodiments of the invention.

### DETAILED DESCRIPTION

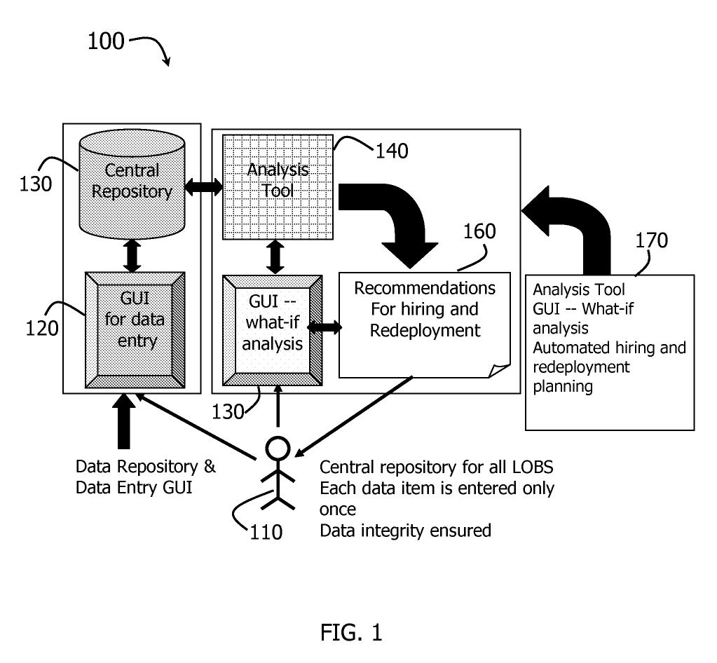

FIG. 1 illustrates an exemplary embodiment of architecture 100 for workforce optimization in accordance with the present invention, especially in a service oriented industry such as a bank, financial institution and the likes. The architecture 100 consists of a user 110 who is provided with a user interface 120 to enter data as input, which are typically planning parameters relevant for a particular business scheme, for example to a data processing system. User interface 120 is configured to receive the inputs from user 110. User interface 120 is interfaces with a central repository 130, the central repository 130 containing a wealth of information that is used advantageously for performing the workforce optimization.

Inputs from user 110 are categorized and the relevant information related to those categories are retrieved from central repository 130 and provided to an analysis tool 140, which for example can be a Microsoft Excel® sheet that is appropriately configured to perform the analysis. Analysis tool 140 is provided with the required software and/or instruction to perform workforce optimization specifically for the service oriented industry. Various known software/instructions/algorithms known in the art can be used for optimization the workforce and such software/instructions/algorithms fall within the scope of the present invention.

In a further embodiment, analysis tool 140 may be coupled to a further user interface 150 which is configured to accept inputs from user 110 to perform a what-if-analysis, based on various scenarios/schemas that user 110 may determine. Such scenarios/schemas may be classified as short term, mid term and long term. For example, user 110 may require a short term plan for planning resource in a banking sector. User 110 may also be provided with a mid term and long term plan considering the various inputs that define what-if-scenarios. This can be computed using user 110 intervention or can be performed automatically without any human intervention.

Analysis tool 140 will be configured to develop a detailed business plan and execute business schemes based on the input from user 110. Analysis tool also takes into considerations various what-if-scenarios as determined by user 110 and/or what-if-scenarios stored in central repository 130 to identify all resources required to perform the business plan. Once the resources are identified, analysis tool 140 is configured to allocate the resources to the business plan. The resource can here include human resource, vehicles, tools and equipments, spare parts, office space etc. It should be apparent to a person skilled in the art that several other resources may be required to execute such business schemes and business plan and such resources fall within the scope of the present invention.

Analysis tool 140 is also configured to make a set of recommendations 160 based on user 110 inputs and also based on the what-if-analysis parameters. Recommendations 160 include intimating the identified resource with the business plan for a particular/identified business scheme based on the inputs (planning parameters) provided. As a preferred embodiment, consider project loan management with a bank or a financial institution. A relatively large percentage of net income for banks comes from net interest income as compared to investments. Faster execution of loan syndication helps in improving a loan closure, which facilitates increase in net interest income. Typically, industries such as banks or financial institutions are identified through an appropriate marketing plan, it will be important to deploy skills “JUST IN TIME” or “on-demand” to appraise applications and sanction loans to a client. There could be various other approaches to identify industries, and it should be apparent to a skilled person that such approaches fall within the scope of the present invention. Banks are expected to overcome competition by ensuring availability of right skills and right resources at the right time. This can be addressed by ensuring optimal allocation of resources to existing workload, optimally acquiring skills based on market forecast and ready state planning to keep up with unforeseen demand, as the volume of applications handled by a bank may increase/decrease in a non-deterministic manner.

It is also important for the bank/financial institution to handle these applications in a timely manner; else the bank is likely to lose business to competition. At the same time inadequate assessment can potentially lead to bad loans and losses for a bank. Therefore, these skills/resources are special as each loan application is unique/non-standard. A disadvantage being that standardized tools cannot be used to process the applications. For example, in India, each application can be 300 pages or more. In some cases, processing an application can take up to 3 months or more. Furthermore, the volume of applications handled by a bank is increasing in a non-deterministic manner. Unless the bank handles these applications in a timely manner, the bank is likely to lose business to competition.

Thus, limited skills/resources are available to identify and evaluate emerging opportunities, to conduct credit and risk assessment capability for corporate enterprise and appraise projects for specific industries. Same skills can be leveraged to ensure regular monitoring of existing portfolio and re-allocation as required.

The present invention provides an architecture which can be easily implemented in a system and method for strategic resource and transition planning for managing corporate banking processes including but not limited to fund/cash management, initial public offer management, treasury management, project loan management etc., which require specialized skills and/or resources. Accordingly, in one embodiment, stochastic-integer programming-based constrained optimization techniques may be employed to develop a strategic resource plan (for example a headcount plan) by optimally allocating resources to tasks belonging to future scenarios associated with occurrence probabilities. For example in one embodiment, such future scenarios can be developed using Bayesian Belief Networks, which can form part of analysis tool 140.

In a further embodiment, stochastic optimization refers to the minimization or maximization of a function in the presence of randomness. It should therefore be apparent to a person skilled in the art that stochastic optimization modeling has been recognized as an effective nonlinear optimization tool for various applications, including the solution of operations research and managerial problems. Accordingly, certain machine-readable data describing process tasks may be subjected to computerized data processing, ultimately producing a determination of valid corporate banking resources with specialized skills and/or resources for each process task in a given time period, which may be used for strategic resource and transition planning for managing the corporate banking processes.

Commonly used practices for resource and transition planning deploy myopic analysis methodologies that are human labor intensive. For example, the resource planning, specifically headcount, exercise for project loan management in banking is carried out with a tactical focus centered only on the needs of the particular Line of Business (LOB). The invention takes a more integrated and strategic approach in analyzing the future demand scenario data across multiple LOB's on a longer planning horizon, with a futuristic perspective. Furthermore, in one embodiment the invention allows for optimized recourse actions on a rolling-horizon and continual operations mode as and when new demand and supply data are realized, thereby being dynamically managed. This approach results in a more robust planning exercise on the face of future uncertain business scenarios.

An exemplary object is to provide a system and method with the architecture 100 for using computer-implemented stochastic optimization modeling to solve problems arising in connection with strategic planning for skilled resources for managing corporate banking processes. Embodiments of the present invention addresses shortcomings of prior art solutions by employing stochastic optimization modeling tools to analyze complex process tasks management scenarios rapidly, with fewer computational resources in order to provide optimal strategic resource planning and tactical resource transition decisions. Embodiments of the present invention thus formulate the problem of analyzing complex process tasks under different probable future scenarios as a multi-stage stochastic optimization model which may be solved using standard mathematical programming solvers.

Accordingly, each future business scenario is associated with an occurrence probability; each scenario includes a set of representative processes and each process is associated with a volume of workload to be handled in a given time period in the planning horizon. The specially skilled resources, for example human resource, can be organized as uni-skilled or multi-skilled resources; have location attributes, and are associated with an availability risk (probability) and productivity numbers.

In addition, using the architecture 100 in a data processing system such as a computer, the following are achieved.
Analyze a strategic utility/benefit metric, e.g. a profit/revenue maximizing objective, under different what-if scenarios involving user-selection of human resources, their locations, and transition decisions;
Generate, in a machine-readable data format, a utility/benefit optimization model of overall strategic utility/benefit under the different planning scenarios; and
Solving a stochastic integer program of a utility/benefit optimization model by solving its deterministic equivalent using a mathematical programming approach.
   where the data processing system is configured to produce as output, preferably in a machine readable data format:
A list of processes, with corresponding unmet demand status, deployed resources, and expected utility;
A list of deployed resources by skill, location; and
A distribution of the optimal utility function values, by each scenario.

In some embodiments, the occurrence probability for each business-scenario may be calculated from historical data which are advantageously fetched from central repository 130. Advantages of using the present invention include:
modeling produces robust optimal hiring, deployment and redeployment decisions in the face of uncertainty; and
solution approach for the resulting optimization model instances is time and memory effective, and it scales well with the problem instance size thereby saving cost, resources and time.

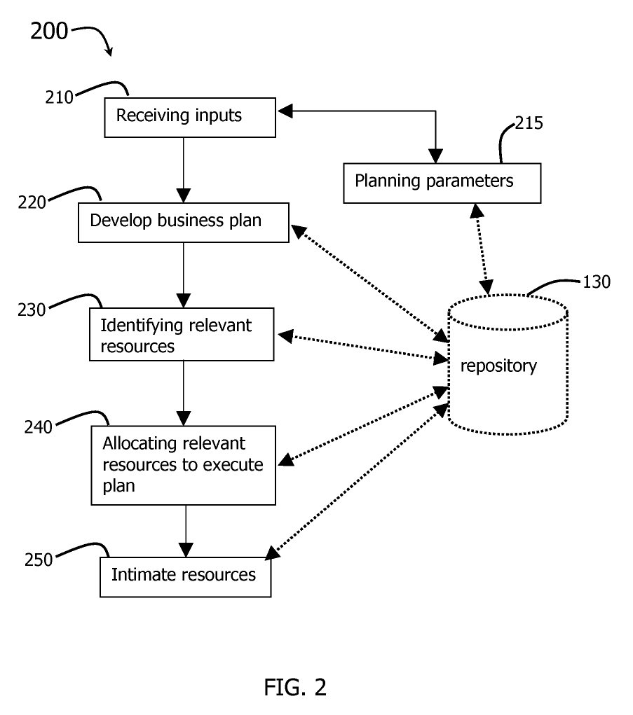

Embodiments of the invention involve execution of the method steps preferably on any computing device involving at least a processor and a memory ranging from desktop computers, laptop computers, PDA's, mobile phones and the likes. FIG. 2 illustrates a flow diagram of an exemplary method for optimizing workforce 200 in accordance with the present invention. Method 200 typically computes workforce optimization in a service oriented industry, for example a banking industry, an insurance company and so on, specifically related to planning and executing a business schedule. In one embodiment, the planning and scheduling can include planning of human resources, for example taking into consideration existing employees and placing a request for hiring resources, until the right resource can be found to complete the plan and execute the business schedule successfully. This can be done with user input or the complete process may be automated or can be a combination thereof of receiving partially receiving user input and partially automating the system.

In Step 210 input are received, these input typically include a variety of business planning parameters, which could vary across each service oriented business. For example the business planning parameter that are found to be relevant to a banking industry would not similar to the business planning parameters 215 that can be used in a call centre. In one embodiment, when the type of industry or service is determined, the method is configured to automatically interface with a repository 130 and retrieve relevant business planning parameters and display such parameters to the user to be authenticated or verified. The user can then modify or customize these parameters as required.

Once the business planning parameters are received in Step 210, the parameters are validated by the user in step 212, as has been discussed previously. This allows the user to tune the parameters as required. For example if the user is new to the system, then the tool 100 is configured to prompt the user to add, modify, delete, cancel etc., any of the parameters that are being used to validate the business model. Once the parameter are validated by the user or automatically, in step 220 a detailed business plan is developed for the business scheme based on the parameters that have been used as inputs. In one embodiment, the process could be iterative by changing the parameters to obtain a better business plan for the business scheme. The business plan can be stored in the repository such that in future instances, when similar input parameter are chosen as planning parameters, a detailed business plan may be provided to the user.

The detailed business plan developed in step 220 involves identifying a set of relevant resources to execute the business plan most efficiently. The resource pool may be available in the repository 130 or any other storage device or software's can be used to maintain a resource pool. Such devices and software's are interfaced with the system such that the user is business plan development phase has all these inputs available to be considered. Such data may be available in structured or unstructured form.

Once the right set of resources have been identified, in step 240 the resources are allocated to the individual tasks of the business plans to execute the business plan. By allocating the resource on a task by task basis, workforce optimization can achieved and the business plan defining the business scheme can be efficiently executed. In step 250 each of the resource is intimated accordingly. For example if a human resource has been identified to meet a customer for creating a insurance policy, the identified human resource is intimated and the human resource is also provided with other resources that are required to achieve this task to be completed in an optimized and efficient manner. At every stage the repository is updated such that for future instances when similar or matching business parameters are provided as inputs, a business plan or multiple plans may be provided to the user in order of preference by an internal ranking mechanism and the user may select the most preferred business plan.

In one embodiment, the identified resource includes a human resource or any one such as a vehicle, tool, equipment or a combination of these resources. Further the planning parameters includes at least one of a list of workload scenarios having a unique IDs, each of the workload occurrences having an occurrence probabilities and a list of skill sets having a unique ID for each work load scenario and a list of human resource with productivity numbers for each of the skilled sets that is identified, tasks to be accomplished under the business scheme and so on. The above only includes an exemplary list of parameters that can be covered, for more complex business schemes, the data required as input parameters can become more complex.

The steps 230 and 240 of identifying and allocating human resource consists of computing a probability distribution of optimal human resource for each of the business plans defined under the business scheme. The steps further consists of ranking the human resource in an ascending order based on the probability distribution or score than is computed and then developing a headcount and a transition plan for allocating the human resource for executing the business plan. Transition plan can be considered as one important factor, because at a given time, not all the right human resources may be available. Therefore, to implement a business plan optimally, human resource may need to be moved around and therefore the transitioning of human resource can be considered as an extremely important step. A small error in the transitioning plan can lead to a failure of the execution of the business plan and the business schemes not only for the business scheme that the plan has been made, but for the existing plan that the human resources may be currently executing. Transitioning also means while moving resources around finding the right replacement resources for execution of tasks that remain un-accomplished.

In one embodiment, the business plan can include future business scenarios over multiple periods of time. Therefore, since the repository is updated with current data, the business plan can be updated dynamically to have the right resources at a given point in time. Updating the repository also computing an associated risk factor with each of the resources, particularly the human resource based on the data available of the human resource and past instances of the human resource. Preferably, access to the repository is limited to certain group of users, for example Managers.

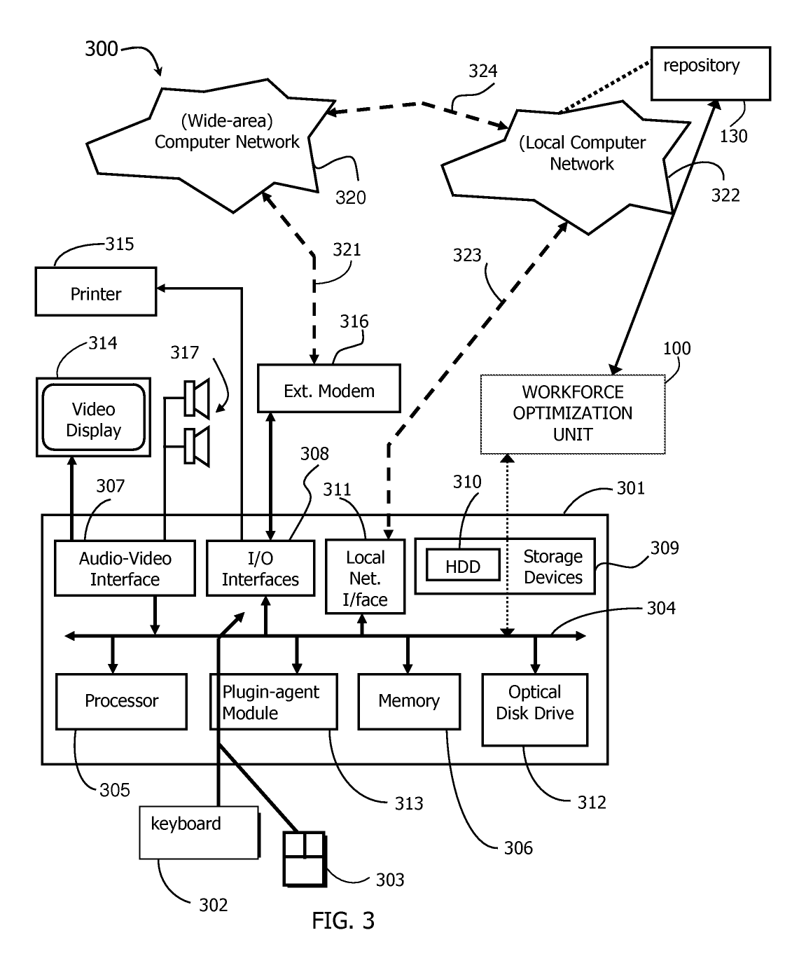

The above embodiments may be implemented using an information handling device 300, for example a computer system, such as that shown in FIG. 3. It should be apparent to one skilled in that art that other information handling devices, such as mobile phones, laptop computers, PDAs, a network of connected computer etc., containing at least a processor and a memory and capable of processing data to execute the method as disclosed above fall within the scope of this invention. The method described previously may be implemented as software, such as, as one or more application programs executable within the device 300 or an additional hardware element 313, wherein the software is embedded in the hardware element 313 and is configured to work in conjunction with the operating system of the device. In particular, the steps of the method may be realized by instructions in the software that are carried out within the device 300. The instructions may be formed as one or more program code modules, each for performing one or more particular tasks. The software may be stored in a readable medium, including the storage devices. In one embodiment, the software is loaded into the device 300 from the readable medium, and then executed by the device 300. A readable medium having such software or program recorded on it is defined as a computer program product.

As seen in FIG. 3, the device 300 is formed by a module 301, input devices such as a keyboard 302 and a mouse pointer device 303, and output devices including a printer 315, a display device 314 and loudspeakers 317. An external Modulator-Demodulator (Modem) transceiver device 316 may be used by the module 301 for communicating to and from a communications network 320 via a connection 321. The network 320 may be a wide-area network (WAN) such as the Internet or a private WAN. Where the connection 321 is a telephone line, the modem 316 may be a traditional “dial-up” modem. Alternatively, where the connection 321 is a high capacity (e.g. cable) connection, the modem 316 may be a broadband modem. A wireless modem may also be used for wireless connection to the network 320.

The module 301 typically includes at least one processor unit 305, and a memory unit 306 for example formed from semiconductor random access memory (RAM) and read only memory (ROM). The module 301 also includes a number of input/output (I/O) interfaces including an audio-video interface 307 that couples to the video display 314 and loudspeakers 317, an I/O interface 308 for the keyboard 302 and mouse 303 and optionally a joystick (not illustrated), for the external modem 316 and printer 315, and optionally the hardware element 313, which when activated performs the method described previously. In some implementations, the modem 316 may be incorporated within the module 301, for example within the interface 308. The module 301 also has a local network interface 311 which, via a connection 323, permits coupling of the device 300 to a local network 322, known as a Local Area Network (LAN). As also illustrated, the local network 322 may also couple to the wide area network 320 via a connection 324, which would typically include a so-called “firewall” device or similar functionality. The network interface 311 may be formed by an Ethernet™ circuit card, a wireless Bluetooth™ or an IEEE 802.11 wireless arrangement.

The optimization module 100 may be part of the software or hardware or an embedded software residing on the device and is configured to perform the method as described previously. The optimization module 100 has been described previously in the art. The optimization module 100 is coupled to a repository 130 which could be local on the system or stored at a different location and interfaced with the system, specifically the optimization module 100 over a network. The optimization module 100 is critical in computing the optimization of workforce in a service oriented industry and developing a business plan, identifying resources, allocating resources and intimating the resources, while taking into account a variety of risk factors. Such an optimization module 100 may be realized as a software code, a hardware element with embedded software or a combination of a hardware and software working in conjunction to achieve perform the steps of the method as described in FIG. 2.

The interfaces 308 may afford both serial and parallel connectivity, the former typically being implemented according to the Universal Serial Bus (USB) standards and having corresponding USB connectors (not illustrated). Storage devices 309 are provided and typically include a hard disk drive (HDD) 310. Other devices such as a floppy disk drive and a magnetic tape drive (not illustrated) may also be used. An optical disk drive 312 is typically provided to act as a non-volatile source of data. Portable memory devices, such optical disks (eg: CD-ROM, DVD), USB-RAM, and floppy disks for example may then be used as appropriate sources of data to the device. A central repository 130 is coupled to the system over the network, where the device is configured to store the registry and also used as a back-up means for the device to store critical information. For each step of execution of the method as described in FIG. 2, the optimization unit 100 can in one embodiment work in conjunction with the repository, either fetching relevant data from the repository 130 or update the repository with relevant data.

The components 305 to 313 of the module 301 typically communicate via an interconnected bus 304 and in a manner which results in a conventional mode of operation of the device 300 known to those in the relevant art. Examples of computers on which the described arrangements can be practiced include IBM-PC's and compatibles, Sun Sparcstations, Apple Mac™ or alike computer systems evolved therefrom.

Typically, the application programs discussed above are resident on the hard disk drive 310 and read and controlled in execution by the processor 305. Intermediate storage of such programs and any data fetched from the networks 320 and 322 may be accomplished using the semiconductor memory 306, possibly in concert with the hard disk drive 310. In some instances, the application programs may be supplied to the user encoded on one or more CD-ROM and read via the corresponding drive 312, or alternatively may be read by the user from the networks 320 or 322. Still further, the software can also be loaded into the device 300 from other readable media, for example computer readable media. Computer readable media refers to any storage medium that participates in providing instructions and/or data to the device 300 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the module 301. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The operations disclosed may alternatively be implemented in dedicated hardware such as one or more integrated circuits performing the functions or sub functions of the described processes. Such dedicated hardware may include graphic processors, digital signal processors, or one or more microprocessors and associated memories.

It should be apparent to a person skilled in the art that the device 300 preferably include a variety of device comprising at least a processor and a memory capable of processing content and are not limited a variety of electronic devices such as desktop computers, application servers, web servers, database servers and the like and portable electronic devices such as mobile phones, personal digital assistants (PDAs), pocket personal computers, laptop computers, electronic devices, portable electronic devices, handheld electronic devices etc falls within the scope of the present invention.

The invention may be implemented with any sort of processing units, processors and controllers (e.g., processor of FIG. 3) capable of executing a program of instructions for performing the stated functions and activities. For example, the processor may be embodied as a microprocessor, microcontroller, DSP, RISC processor, or any other type of processor that one of ordinary skill would recognize as being capable of performing the functions described herein. A processing unit in accordance with at least one exemplary embodiment can operate computer software programs stored (embodied) on computer-readable medium such as the internal memory or storage drive, e.g. hard disk, CD, flash memory, ram, or other machine readable medium as recognized by one of ordinary skill in the art. The computer software or other programs of instructions can aid or perform the steps and activities described above. For example computer programs in accordance with at least one exemplary embodiment may include: source code for performing the method steps as disclosed above.

The use of the word “exemplary” in this disclosure is intended to mean that the embodiment or element so described serves as an example, instance, or illustration, and is not necessarily to be construed as preferred or advantageous over other embodiments or elements. The description of the various exemplary embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the spirit and scope of the present invention.

1. A system for workforce optimization comprising a workforce optimization unit configured to perform planning and executing a business scheme, the workforce optimization unit configured to:
receive as input business planning parameters relevant to the business scheme;
develop a business plan to execute the business scheme based on the business planning parameters;
identify and allocating relevant resources for executing the business plan; and
intimate the identified resources with the plan to execute the business scheme.

2. The system of claim 1, wherein the identified resource for executing the business plan includes a human resource.

3. The system of claim 1, wherein the identified resource for executing the business plan further includes one of a vehicle, or tools and equipment or spare parts or office space.

4. The system of claim 1, wherein the planning parameters received as input by the workforce optimization unit includes at least one of a list of workload scenarios having unique IDs, each of the workload occurrence having an occurrence probabilities and a list of skill sets having unique IDs for each workload scenario and a list of existing human resources with productivity numbers for each skill set, and tasks to be accomplished in the business scheme.

5. The system of claim 2, wherein to identify and allocate human resource, the workforce optimization unit is configured to:
compute a probability distribution of optimal human resource for each of the business plan;
rank the human resource in an ascending order based on the probability distribution; and
develop a headcount and transition plan for allocating the human resource for executing the business plan.

6. The system of claim 1, wherein the workforce optimization unit is configured to generate future business scenarios planned over multiple time periods from the input parameters received.

7. The system of claim 5, wherein the workforce optimization unit is configured to computer a risk factor with the human resource.

8. The system of claim 7, wherein the risk factor is computed by means of a probability distribution.

9. The system of claim 1, wherein the planning parameters, business schema, business plan and human resource are stored in a repository.

10. The system of claim 9, wherein the repository includes at least one of a structured or unstructured data.

11. The system of claim 9, wherein the work optimization unit is configured to dynamically update the repository on negative determination.

12. The system of claim 11, wherein access to the central repository is limited to a pre-defined group of users.

13. The system of claim 1, wherein the business scheme includes at least one of a financial or an insurance deal.

14. A system for workforce optimization comprising at least a processor and a memory, the system further comprising a workforce optimization unit configured to perform planning and executing a business scheme, the workforce optimization unit configured to:
receive as input business planning parameters relevant to the business scheme;
develop a business plan to execute the business scheme based on the business planning parameters;
identify and allocating relevant resources for executing the business plan, wherein the identified resource for executing the business plan includes at least one of a human resource, a vehicle, or tools and equipment or spare parts or office space a human resource; and
intimate the identified resources with the plan to execute the business scheme.

15. The system of claim 14, wherein the planning parameters received as input by the workforce optimization unit includes at least one of a list of workload scenarios having unique IDs, each of the workload occurrence having an occurrence probabilities and a list of skill sets having unique IDs for each workload scenario and a list of existing human resources with productivity numbers for each skill set, and tasks to be accomplished in the business scheme.

16. The system of claim 14, wherein to identify and allocate human resource, the workforce optimization unit is configured to:
compute a probability distribution of optimal human resource for each of the business plan;
rank the human resource in an ascending order based on the probability distribution; and
develop a headcount and transition plan for allocating the human resource for executing the business plan.

17. The system of claim 14, wherein the workforce optimization unit is configured to generate future business scenarios planned over multiple time periods from the input parameters received.

18. The system of claim 5, wherein the workforce optimization unit is configured to computer a risk factor with the human resource, the risk factor being computed by means of a probability distribution.

19. The system of claim 1, wherein the planning parameters, business schema, business plan and human resource are stored in a repository, the repository includes at least one of a structured or unstructured data, and the work optimization unit is configured to dynamically update the repository on negative determination.

20. A computer program product comprising a computer useable medium having computer useable program code for workforce optimization, the computer program product comprising:
computer usable program code to receive as input business planning parameters relevant to the business scheme;
computer usable program code to develop a business plan to execute the business scheme based on the business planning parameters;
computer usable program code to identify and allocating relevant resources for executing the business plan, wherein the identified resource for executing the business plan includes at least one of a human resource, a vehicle, or tools and equipment or spare parts or office space a human resource; and
computer usable program code to intimate the identified resources with the plan to execute the business scheme.
